(19) United States
(12) Patent Application Publication
(10) Pub. No.: US 2026/0213270 A1
(43) Pub. Date: Jul. 23, 2026

(54) ELECTROLYTE COMPOSITION

(71) Applicant: Dyson Technology Limited, Malmesbury, Wiltshire (GB)

(72) Inventors: Yu HU, Swindon (GB); Matthew Robert ROBERTS, Oxford (GB); Connor GRAY, Chippenham (GB)

(21) Appl. No.: 19/138,161

(22) PCT Filed: Dec. 4, 2023
(86) PCT No.: PCT/IB2023/062197

§ 371 Date: Jun. 12, 2025

(30) Foreign Application Priority Data
Dec. 13, 2022 (GB) 2218747.0

(51) Int. Cl. H01M 10/0569; H01M 10/0525; H01M 10/0568

(52) U.S. Cl. CPC H01M 10/0569; H01M 10/0525; H01M 10/0568; H01M 2300/0042

(57) ABSTRACT

An electrolyte composition that includes a solvent component, the solvent including ethyl acetate and a lithium salt component including one or more lithium salts, and where the concentration of the lithium salt component in the electrolyte composition is greater than 1.0 mol·dm⁻³ but less than 3.0 mol·dm⁻³. The electrolyte composition is as useful as an electrolyte in an alkali metal secondary cell, for example a lithium-ion cell or lithium metal cell.

### FIELD OF THE INVENTION

The present invention relates to an electrolyte composition, a hybrid electrolyte composition and electrochemical cells containing such compositions. Uses of these and methods for their manufacture are also disclosed.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells, which is one example of an alkali metal ion secondary cell.

Modern applications of lithium-ion batteries, such as electric vehicles and other high-power devices, require high rate performance of the battery. In other words, the battery should perform well (for example, retaining high capacity) when operated at a high discharge rate.

This enables the devices being operated by the batteries to have an extended runtime.

The electrolyte used in the cell can have an effect on rate performance and power performance.

Conventional liquid electrolytes have not changed much for nearly 40 years, usually comprising a solution of LiPF₆ salt in a combination of two or more carbonate-based solvents, predominately a mixture of cyclic and linear carbonates and some SEI-forming additives. The limitations of rate and power performance of such liquid electrolytes impedes the advancement of lithium-ion battery applications towards high voltage and high-power applications, in particular impeding compatibility with high-voltage cathodes and next-generation Li-metal cells.

There is a need for electrolytes which offer improved rate performance and improved power performance when used within alkali metal ion secondary cells, such as lithium-ion cells and lithium-metal cells.

### SUMMARY OF THE INVENTION

The invention relates generally to an electrolyte composition for use in alkali metal ion secondary cells, and in particular to an electrolyte composition comprising a particular mixture of solvent component and lithium salt component.

A first aspect of the invention is an electrolyte composition comprising:
a solvent component comprising ethyl acetate; and
a lithium salt component comprising one or more lithium salts;
wherein the concentration of the lithium salt component in the electrolyte composition is from greater than 1.0 mol·dm⁻³ to less than 3.0 mol·dm⁻³.

The electrolyte offers a high rate capability, with higher discharge capacities being achievable even at high discharge rates such as 5C or 10C when compared with traditional electrolytes. This allows a cell incorporating the electrolyte to deliver at high power for longer periods, effectively extending the lifetime of a high-power device powered by the cell.

Without wishing to be bound by theory, it is believed that the solvent component of the cell comprising ethyl acetate offers benefits over traditional cells containing carbonate-based solvents. The ethyl acetate when used in combination with the lithium salt component at a concentration of from greater than 1.0 mol·dm⁻³ to less than 3.0 mol·dm⁻³ provides high ionic conductivity and reduced internal resistance of the cell, leading to the observed increase in rate capability. Moreover, the use of ethyl acetate provides an electrolyte having much lower viscosity than traditional electrolytes based on carbonate solvents.

Without wishing to be bound by theory, it is believed that the lower viscosity of ethyl acetate (EA) provides higher performance through the enablement of higher diffusion coefficients, since viscosity of electrolyte is strongly correlated with the diffusion coefficient of Li and thereby conductivity.

Sometimes cells are made by incorporating a high boiling point electrolyte in a thermal process. The incorporation of EA in a thermal process is difficult as it will likely evaporate due to having a lower boiling point.

To address this a second aspect of the invention provides a hybrid electrolyte composition comprising a blend of:
(a) a first blend component consisting of an electrolyte composition according to the first aspect; and
(b) a second blend component consisting of a secondary electrolyte composition comprising a secondary solvent component and a secondary lithium salt component.

A unique property of the electrolyte according to the first aspect is that it offers a means to augment the performance of existing (high boiling point) electrolytes by incorporating some of the electrolyte of the first aspect. The result is the hybrid electrolyte of the second aspect, which will offer improved ionic conductivity, reduced internal resistance of a cell incorporating the hybrid electrolyte, and better rate capability, when compared with the second blend component used alone, as well as facilitating the incorporation of the electrolyte into a cell using traditional thermal processes. In this way, the electrolyte according to the first aspect can be considered a “rate boosting” additive which can be combined with existing electrolytes to improve their rate capability.

A third aspect of the invention is an electrochemical secondary cell comprising an anode;
a cathode;
a separator between the anode and the cathode; and either
   (a) an electrolyte composition according to the first aspect; or
   (b) a hybrid electrolyte composition according to the second aspect.

A fourth aspect of the invention is an electrochemical energy storage device comprising one or more electrochemical secondary cells according to the third aspect.

A fifth aspect of the invention is a method of manufacturing the electrolyte composition according to the first aspect, comprising the steps:
(a) providing a solvent component comprising ethyl acetate; and
(b) adding a lithium salt component comprising one or more lithium salts to the solvent component, such that the final concentration of the lithium salt component in the electrolyte composition is from greater than 1.0 mol·dm⁻³ to less than 3.0 mol·dm⁻³.

A sixth aspect of the invention is a method of producing the hybrid electrolyte composition of the second aspect, comprising mixing a first blend component consisting of an electrolyte composition according to the first aspect with a second blend component consisting of a secondary electrolyte composition comprising a secondary solvent component and a secondary lithium salt component.

A seventh aspect of the invention is a method of producing an electrochemical secondary cell of the third aspect, comprising:
(a) assembling an anode, a cathode and a separator together; and
(b) introducing the electrolyte composition according to the first aspect or the hybrid electrolyte composition according to the second aspect into the cell to facilitate ionic conduction between the anode and the cathode.

The invention also provides the use of an electrolyte composition according to the first aspect in an electrochemical secondary cell. The invention also provides the use of an electrolyte composition according to the first aspect to increase the ionic conductivity within an electrochemical secondary cell. The invention also provides the use of an electrolyte composition according to the first aspect to reduce the internal resistance within an electrochemical secondary cell. The invention also provides the use of an electrolyte composition according to the first aspect to increase the rate capability of an electrochemical secondary cell. The invention also provides the use of an electrolyte composition according to the first aspect as an additive to increase the rate capability of a second electrolyte composition.

The invention also provides a method of increasing the rate capability of a second electrolyte composition, comprising adding the electrolyte composition according to the first aspect to the second electrolyte composition.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

A first aspect of the invention is an electrolyte composition comprising:
a solvent component comprising ethyl acetate; and
a lithium salt component comprising one or more lithium salts;
wherein the concentration of the lithium salt component in the electrolyte composition is from greater than 1.0 mol·dm⁻³ to less than 3.0 mol·dm⁻³.

In some embodiments, the solvent component comprises from 5 to 100 wt % ethyl acetate, for example from 6 to 100 wt %, from 8 to 100 wt %, or from 10 to 100 wt %. In some embodiments, the solvent component comprises from 50 to 100 wt % ethyl acetate, for example from 60 to 100 wt %, or from 80 to 100 wt %.

In some embodiments, the solvent component comprises at least 30 wt % ethyl acetate, based on the total weight of solvent component, for example at least 32 wt %, at least 34 wt %, at least 36 wt %, at least 38 wt % or at least 40 wt %.

In some embodiments, the solvent component comprises at least 50 wt % ethyl acetate, based on the total weight of solvent component, for example at least 51 wt %, at least 52 wt %, at least 53 wt %, at least 54 wt % or at least 55 wt %.

In some embodiments, the solvent component comprises at least 70 wt % ethyl acetate, based on the total weight of solvent component, for example at least 75 wt %, at least 80 wt %, at least 85 wt % or at least 90 wt %. In some embodiments, the solvent component comprises from 70 wt % to 95 wt % ethyl acetate, for example from 70 wt % to 90 wt %.

In some embodiments, the solvent component consists essentially of ethyl acetate. In some embodiments, the solvent component consists of ethyl acetate. In other words, the solvent component may contain ethyl acetate as sole solvent component, with no co-solvent being present.

In some embodiments, the solvent component comprises ethyl acetate and at least one co-solvent. In some embodiments the at least one co-solvent is selected from one or more organic carbonate compounds. In some embodiments the at least one co-solvent is selected from one or more of ethylene carbonate (EC) and dimethyl carbonate (DMC).

In some embodiments, the solvent component comprises ethyl acetate and one or two co-solvents independently selected from organic carbonate compounds. In some embodiments, the solvent component comprises ethyl acetate and one or two co-solvents independently selected from EC and DMC.

In some embodiments, the solvent component contains less than 60 wt % organic carbonate compounds, for example less than 55 wt % or less than 50 wt %, based on the total weight of solvent component. Herein, “organic carbonate compound” refers to any linear or cyclic organic compound of the general formula R¹O(C═O)OR², wherein R¹ and R² are each independently optionally substituted alkyl groups, or together with the oxygen atoms to which they are attached may form an optionally substituted heterocyclic ring. Dimethyl carbonate (DMC), diethyl carbonate, ethyl methyl carbonate and ethylene carbonate (EC) are examples of organic carbonate compounds.

In some embodiments, the solvent component contains less than 30 wt % organic carbonate compounds, based on the total weight of solvent component, for example less than 25 wt %, less than 20 wt %, less than 15 wt %, less than 10 wt %, less than 5 wt %, less than 2 wt % or less than 1 wt %.

In some embodiments, the solvent component contains no, or substantially no, organic carbonate compounds.

In some embodiments, the solvent component contains less than 30 wt % ethylene carbonate, based on the total weight of solvent component, for example less than 25 wt %, less than 20 wt %, less than 15 wt %, less than 10 wt %, less than 5 wt %, less than 2 wt % or less than 1 wt %. In some embodiments, the solvent component contains less than 30 wt % dimethyl carbonate, based on the total weight of solvent component, for example less than 25 wt %, less than 20 wt %, less than 15 wt %, less than 10 wt %, less than 5 wt %, less than 2 wt % or less than 1 wt %.

In some embodiments, the electrolyte composition contains less than 30 wt % organic carbonate compounds, based on the total weight of electrolyte composition, for example less than 25 wt %, less than 20 wt %, less than 15 wt %, less than 10 wt %, less than 5 wt %, less than 2 wt % or less than 1 wt %.

In some embodiments, the electrolyte composition contains less than 30 wt % ethylene carbonate, based on the total weight of electrolyte composition, for example less than 25 wt %, less than 20 wt %, less than 15 wt %, less than 10 wt %, less than 5 wt %, less than 2 wt % or less than 1 wt %. In some embodiments, the electrolyte composition contains less than 30 wt % dimethyl carbonate, based on the total weight of electrolyte composition, for example less than 25 wt %, less than 20 wt %, less than 15 wt %, less than 10 wt %, less than 5 wt %, less than 2 wt % or less than 1 wt %.

In some embodiments, the solvent component is the only solvent component in the electrolyte composition. In other words, the solvent component may be the only component in the electrolyte composition providing a solvating function, and no further solvent components are present. In some embodiments, the electrolyte composition consists of, or consists essentially of, the solvent component, the lithium salt component and an optional auxiliary solvent component described in more detail below.

In some embodiments, the solvent component is non-aqueous. In some embodiments, the solvent component comprises no water, or an amount of water less than 1000 ppm by weight based on the total weight of solvent component, for example less than 900 ppm, less than 800 ppm, less than 700 ppm, less than 600 ppm, less than 500 ppm, less than 400 ppm, less than 300 ppm, less than 200 ppm or less than 100 ppm. In some embodiments, the solvent component comprises no water, or an amount of water less than 10 ppm by weight based on the total weight of solvent component, for example less than 5 ppm.

In some embodiments, the electrolyte composition is non-aqueous. In some embodiments, the electrolyte composition comprises no water, or an amount of water less than 1000 ppm by weight based on the total weight of electrolyte composition, for example less than 900 ppm, less than 800 ppm, less than 700 ppm, less than 600 ppm, less than 500 ppm, less than 400 ppm, less than 300 ppm, less than 200 ppm or less than 100 ppm. In some embodiments, the electrolyte composition comprises no water, or an amount of water less than 10 ppm by weight based on the total weight of electrolyte composition, for example less than 5 ppm.

If too much water is present in the electrolyte then the electrochemical stability window of the electrolyte is affected and the water can be broken down, negatively impacting the performance of the cell. Energy, rate and cyclability aspects of cell performance can be jeopardised by this. The water could also become involved in unwanted side-reactions with salts and solvents, which can be a problem in all electrolytes but is particularly problematic if LiPF₆ is present.

Water may be removed from the solvent component by a suitable method known to the skilled person, for example using molecular sieves, to achieve a water content within the range described above.

The lithium salt component comprises one or more lithium salts and the concentration of the lithium salt component in the electrolyte composition is from greater than 1.0 mol·dm⁻³ to less than 3.0 mol-dm-3.

In some embodiments, the lithium salt component comprises one or more of lithium hexafluorophosphate (LiPF₆), lithium bis(trifluoromethanesulfonyl)imide (LiTFSI), lithium bis(fluorosulfonyl)imide (LiFSI), lithium difluoro(oxalato)borate (LiDFOB), lithium difluorophosphate and lithium bis(oxalato) borate.

In some embodiments, the lithium salt component comprises, or consists of, one or more of LiPF₆, LiDFOB, LiTFSI and LiFSI. In some embodiments, the lithium salt component comprises one or more of LiPF₆, LiTFSI and LiFSI. In some embodiments, the lithium salt component comprises, or consists of, one or more of LiPF₆, LiDFOB, and LiFSI.

In some embodiments, the lithium salt component comprises, or consists of, one or more of LiTFSI and LiFSI.

In some embodiments, the lithium salt component comprises, or consists of, one or more of LiTFSI and LiFSI, optionally in combination with LiPF₆.

In some embodiments, the lithium salt component comprises, or consists of, a mixture of LiDFOB and LiFSI.

In some embodiments, the lithium salt component consists of, or consists essentially of, a mixture of LiPF₆ and LiFSI. In some embodiments, the lithium salt component comprises from about 1 wt % to about 50 wt % LiPF₆, for example from about 5 wt % to about 45 wt %, from about 5 wt % to about 40 wt %, from about 5 wt % to about 35 wt %, from about 5 wt % to about 30 wt %, from about 5 wt % to about 20 wt %, from about 5 wt % to about 15 wt %, from about 5 wt % to about 10 wt %, from about 10 wt % to about 40 wt %, from about 10 wt % to about 35 wt % or from about 10 wt % to about 30 wt %, based on the total weight of lithium salt component. In some embodiments, the lithium salt component comprises LiPF₆ in this amount and the balance of the lithium salt component is LiFSI.

Without wishing to be bound by theory, it is believed that the presence of LiPF₆ in this amount, alongside LiFSI, provides improved cyclability of a cell comprising the electrolyte composition. Again without wishing to be bound by theory, it is believed that the presence of LiPF₆ may provide this improvement through an improvement in Al passivation.

In some embodiments, the lithium salt component consists of, or consists essentially of, a mixture of LiDFOB and LiFSI. In some embodiments, the lithium salt component comprises from about 1 wt % to about 50 wt % LiDFOB, for example from about 5 wt % to about 45 wt %, from about 5 wt % to about 40 wt %, from about 5 wt % to about 35 wt %, from about 5 wt % to about 30 wt %, from about 5 wt % to about 20 wt %, from about 5 wt % to about 15 wt % or from about 5 wt % to about 10 wt %, based on the total weight of lithium salt component. In some embodiments, the lithium salt component comprises LiDFOB in this amount and the balance of the lithium salt component is LiFSI.

In some embodiments, the lithium salt component consists of, or consists essentially of, a single type of lithium salt. This provides a simple electrolyte composition containing a single type of lithium salt which is straightforward to manufacture.

In some embodiments, the lithium salt component comprises from about 50 wt % to about 100 wt % LiFSI, for example from about 55 wt % to about 100 wt %, from about 60 wt % to about 100 wt %, from about 70 wt % to about 100 wt %, from about 80 wt % to about 100 wt %, from about 85 wt % to about 100 wt %, from about 85 wt % to about 95 wt % or from about 90 wt % to about 95 wt %, based on the total weight of lithium salt component.

In some embodiments, the lithium salt component consists of, or consists essentially of, LiFSI. Despite the potential improvement in cyclability arising from the presence of LiPF₆, it may nevertheless be desirable to provide a lithium salt component consisting of, or consisting essentially of, LiFSI, because this provides a simple electrolyte composition containing a single type of lithium salt which is straightforward to manufacture. Furthermore, it has been found that LiFSI offers a high bulk ionic conductivity, so the sole use of LiFSI may be preferred to the sole use of other lithium salts such as LiPF₆.

In some embodiments the concentration of the lithium salt component in the electrolyte composition is at least 1.01 mol·dm⁻³, for example at least 1.1 mol·dm⁻³, at least 1.15 mol·dm⁻³, at least 1.2 mol·dm⁻³, at least 1.25 mol·dm⁻³, at least 1.3 mol·dm⁻³, at least 1.35 mol·dm⁻³, at least 1.4 mol·dm⁻³, at least 1.45 mol·dm⁻³, at least 1.5 mol·dm⁻³, at least 1.55 mol·dm⁻³, at least 1.6 mol·dm⁻³, at least 1.65 mol·dm⁻³ or at least 1.7 mol·dm⁻³.

In some embodiments the concentration of the lithium salt component in the electrolyte composition is up to 2.99 mol·dm⁻³, for example up to 2.9 mol·dm⁻³, up to 2.85 mol·dm⁻³, up to 2.8 mol·dm⁻³, up to 2.75 mol·dm⁻³, up to 2.7 mol·dm⁻³, up to 2.65 mol·dm⁻³, up to 2.6 mol·dm⁻³, up to 2.55 mol·dm⁻³, up to 2.5 mol·dm⁻³, up to 2.45 mol·dm⁻³, up to 2.4 mol-dm-3, up to 2.35 mol·dm⁻³ or up to 2.3 mol·dm⁻³.

In some embodiments the concentration of the lithium salt component in the electrolyte composition is from 1.1 mol·dm⁻³ to less than 3.0 mol·dm⁻³, for example from 1.1 mol·dm⁻³ to 2.9 mol·dm⁻³, from 1.2 mol·dm⁻³ to 2.8 mol·dm⁻³, from 1.3 mol·dm⁻³ to 2.8 mol·dm⁻³, from 1.4 mol·dm⁻³ to 2.8 mol·dm⁻³, from 1.5 mol·dm⁻³ to 2.8 mol·dm⁻³, from 1.2 mol·dm⁻³ to 2.7 mol·dm⁻³, from 1.2 mol·dm⁻³ to 2.6 mol·dm⁻³, from 1.2 mol·dm⁻³ to 2.5 mol·dm⁻³, from 1.3 mol·dm⁻³ to 2.8 mol·dm⁻³, from 1.3 mol·dm⁻³ to 2.7 mol·dm⁻³, from 1.3 mol·dm⁻³ to 2.6 mol·dm⁻³, from 1.3 mol·dm⁻³ to 2.5 mol·dm⁻³, from 1.4 mol·dm⁻³ to 2.7 mol·dm⁻³, from 1.4 mol·dm⁻³ to 2.6 mol·dm⁻³, from 1.4 mol·dm⁻³ to 2.5 mol·dm⁻³, from 1.5 mol·dm⁻³ to 2.5 mol·dm⁻³, from 1.6 mol·dm⁻³ to 2.5 mol·dm⁻³, from 1.6 mol·dm⁻³ to 2.4 mol·dm⁻³, from 1.7 mol·dm⁻³ to 2.4 mol·dm⁻³, from 1.7 mol·dm⁻³ to 2.3 mol-dm-3.

It has been found that such “intermediate” salt component concentrations provide an electrolyte composition having improved cell rate capability comparative compositions of “low” (e.g. 1.0 mol·dm⁻³ or lower) or “high” (e.g. 3.0 mol·dm⁻³ or higher) salt component concentration.

Furthermore, avoiding “high” salt component concentrations of 3.0 mol·dm⁻³ or higher reduces the cost of the electrolyte and reduces the viscosity.

In some embodiments the concentration of the lithium salt component in the electrolyte composition is greater than 0.8 mol·kg⁻¹, for example at least 0.81 mol·kg⁻¹, at least 0.82 mol·kg⁻¹, at least 0.83 mol·kg⁻¹, at least 0.84 mol·kg⁻¹, at least 0.85 mol·kg⁻¹, at least 0.9 mol·kg⁻¹, at least 1.0 mol·kg⁻¹, at least 1.2 mol·kg⁻¹ or at least 1.4 mol·kg⁻¹.

In some embodiments the concentration of the lithium salt component in the electrolyte composition is less than 2.5 mol·kg⁻¹, for example up to 2.4 mol·kg⁻¹, up to 2.3 mol·kg⁻¹, up to 2.2 mol·kg⁻¹, up to 2.1 mol·kg⁻¹, up to 2.0 mol·kg⁻¹ or up to 1.9 mol·kg⁻¹.

In some embodiments the concentration of the lithium salt component in the electrolyte composition is from 0.83 mol·kg⁻¹ to less than 2.5 mol·kg⁻¹, for example from 0.84 mol·kg⁻¹ to 2.5 mol·kg⁻¹, from 0.85 mol·kg⁻¹ to 2.4 mol·kg⁻¹, from 0.85 mol·kg⁻¹ to 2.3 mol·kg⁻¹, from 0.85 mol·kg⁻¹ to 2.2 mol·kg⁻¹, from 0.9 mol·kg⁻¹ to 2.0 mol·kg⁻¹, from 1.0 mol·kg⁻¹ to 2.0 mol·kg⁻¹, from 1.1 mol·kg⁻¹ to 2.0 mol·kg⁻¹, from 1.2 mol·kg⁻¹ to 2.0 mol·kg⁻¹, from 1.3 mol·kg⁻¹ to 2.0 mol·kg⁻¹ or from 1.4 mol·kg⁻¹ to 1.9 mol·kg⁻¹.

In some embodiments, a higher concentration of the lithium salt component is present in the electrolyte composition when the amount of ethyl acetate in the solvent component is higher.

In some embodiments, the solvent component consists of a mixture of EA and EC, and the concentration of the salt component satisfies the relationship:

$$[ SC ] = x / {P}_{EA}$$

wherein [SC] is the concentration of the salt component in the electrolyte composition in mol·dm⁻³;
x is from 40 to 60; and
P_{EA} is the amount of ethyl acetate in the solvent component, in wt % based on the total amount of solvent component.

In some embodiments, x is from 45 to 65, or x is about 50. In some embodiments, x is 50.

In some embodiments, the solvent component consists of a mixture of EA and EC, the salt component consists of LiFSI, and the concentration of the salt component satisfies the relationship:

$$[ SC ] = x / {P}_{EA}$$

wherein [SC] is the concentration of the salt component in the electrolyte composition in mol·dm⁻³;
x is from 40 to 60; and
P_{EA} is the amount of ethyl acetate in the solvent component, in wt % based on the total amount of solvent component.

In some embodiments, the electrolyte composition further comprises an auxiliary solvent component. The auxiliary solvent component may comprise one or more of vinylene carbonate (VC), vinyl ethylene carbonate (VEC), 1,3-propane sultone (PS), and fluoroethylene carbonate (FEC). In some cases, the auxiliary solvent component consists essentially of or consists of vinylene carbonate and fluoroethylene carbonate. In some cases, the weight ratio of vinylene carbonate and fluoroethylene carbonate in the auxiliary solvent component is from about 1:2 to about 3:1, suitably about 2:1.

Without wishing to be bound by theory, it is believed that the presence of a small amount of auxiliary solvent component may help to stabilise the anode.

In some embodiments, the electrolyte composition comprises less than 10 wt % auxiliary solvent component, based on the total weight of the electrolyte composition, for example less than 9 wt %, less than 8 wt %, less than 7 wt %, less than 6 wt % or less than 5 wt %.

In some embodiments, the electrolyte composition comprises about 4-8 wt % of auxiliary solvent component, suitably about 5-8 wt % or 6-7 wt % of auxiliary solvent component, based on the total weight of the electrolyte composition.

The use of the auxiliary solvent component in these amounts helps provide stability for the anode without any detrimental effect on the cathode which may be arise from the use of excessive quantities of auxiliary solvent component.

In some embodiments the auxiliary solvent component consists of a mixture of VC and FEC. In some embodiments the auxiliary solvent component comprises from 50 to 90 wt % VC, for example from 50 to 80 wt %, from 50 to 70 wt %, from 60 to 70 wt % or from 65 to 70 wt %, based on the total weight of auxiliary solvent component. In some embodiments, the auxiliary solvent component comprises VC in this amount, and the balance is FEC.

In some embodiments, the electrolyte composition further comprises one or more non-solvent additives. The skilled person is aware of possible additives for use in such electrolyte compositions. Non-limiting examples of possible additives include salts such as LiTDI, silane salts and phosphorus containing salts. In some embodiments, the one or more non-solvent additives, when present in the electrolyte composition, are present in an amount of up to 5 wt % based on the total weight of the electrolyte composition, for example up to 4 wt %, up to 3 wt %, up to 2 wt % or up to 1 wt %. In some embodiments, the one or more non-solvent additives, when present in the electrolyte composition, are present in an amount of from 0.1 to 5 wt % based on the total weight of the electrolyte composition, for example from 0.1 to 4 wt %, from 0.1 to 3 wt %, from 0.1 to 2 wt % or from 0.1 to 1 wt %.

In some embodiments, the electrolyte composition comprises:
from 47 wt % to 90 wt % of a solvent component comprising, or consisting of, ethyl acetate;
from 10 wt % to 45 wt % a lithium salt component comprising, or consisting of, one or more lithium salts;
optionally from 4 wt % to 8 wt % of an auxiliary solvent component comprising, or consisting of, one or more of vinylene carbonate (VC), vinyl ethylene carbonate (VEC), 1,3-propane sultone (PS), and fluoroethylene carbonate (FEC);
wherein the concentration of the lithium salt component in the electrolyte composition is from greater than 1.0 mol·dm⁻³ to less than 3.0 mol·dm⁻³; and
wherein the total amount of the solvent component, the lithium salt component and the optional auxiliary solvent component is 100 wt %.

In some embodiments, the electrolyte composition comprises:
from 47 wt % to 90 wt % of a solvent component comprising, or consisting of, ethyl acetate or a mixture of ethyl acetate and ethylene carbonate;
from 10 wt % to 45 wt % a lithium salt component comprising, or consisting of, one or more of lithium hexafluorophosphate (LiPF₆), lithium bis(trifluoromethanesulfonyl)imide (LiTFSI), lithium bis(fluorosulfonyl)imide (LiFSI), lithium difluoro(oxalato)borate, lithium difluorophosphate and lithium bis(oxalato) borate;
optionally from 4 wt % to 8 wt % of an auxiliary solvent component comprising, or consisting of, one or more of VC, VEC, PS, and FEC;
wherein the concentration of the lithium salt component in the electrolyte composition is from greater than 1.0 mol·dm⁻³ to less than 3.0 mol·dm⁻³; and
wherein the total amount of the solvent component, the lithium salt component and the optional auxiliary solvent component is 100 wt %.

In some embodiments, the electrolyte composition comprises:
from 47 wt % to 90 wt % of a solvent component comprising, or consisting of, ethyl acetate or a mixture of ethyl acetate and ethylene carbonate;
from 10 wt % to 45 wt % a lithium salt component comprising, or consisting of, lithium bis(fluorosulfonyl)imide (LiFSI), and optionally one or more further lithium salts selected from lithium hexafluorophosphate (LiPF₆), lithium bis(trifluoromethanesulfonyl)imide (LiTFSI), lithium bis(fluorosulfonyl)imide (LiFSI), lithium difluoro(oxalato)borate, lithium difluorophosphate and lithium bis(oxalato) borate;
optionally from 4 wt % to 8 wt % of an auxiliary solvent component comprising, or consisting of, one or more of VC, VEC, PS, and FEC;
wherein the concentration of the lithium salt component in the electrolyte composition is from greater than 1.0 mol·dm⁻³ to less than 3.0 mol·dm⁻³; and
wherein the total amount of the solvent component, the lithium salt component and the optional auxiliary solvent component is 100 wt %.

In some embodiments, the electrolyte composition comprises:
from 47 wt % to 90 wt % of a solvent component comprising, or consisting of, ethyl acetate or a mixture of ethyl acetate and ethylene carbonate;
from 10 wt % to 45 wt % a lithium salt component comprising, or consisting of, lithium bis(fluorosulfonyl)imide (LiFSI), and optionally one or more further lithium salts selected from lithium hexafluorophosphate (LiPF₆), lithium bis(trifluoromethanesulfonyl)imide (LiTFSI), lithium bis(fluorosulfonyl)imide (LiFSI), lithium difluoro(oxalato)borate, lithium difluorophosphate and lithium bis(oxalato) borate;
optionally from 5 wt % to 8 wt % of an auxiliary solvent component comprising, or consisting of, one or more of VC, VEC, PS, and FEC;
wherein the concentration of the lithium salt component in the electrolyte composition is from greater than 1.5 mol·dm⁻³ to less than 2.8 mol·dm⁻³; and
wherein the total amount of the solvent component, the lithium salt component and the optional auxiliary solvent component is 100 wt %.

In some embodiments, the specific conductance of the electrolyte composition is at least 1 mS/cm, for example at least 2 mS/cm, at least 3 mS/cm, at least 4 mS/cm, at least 5 mS/cm, at least 6 mS/cm, at least 7 mS/cm, at least 8 mS/cm, at least 9 mS/cm, at least 10 mS/cm, at least 15 mS/cm or at least 20 mS/cm.

In some embodiments, the specific conductance of the electrolyte composition is from 1 mS/cm to 25 mS/cm, for example from 2 mS/cm to 25 mS/cm, from 5 mS/cm to 25 mS/cm, from 10 mS/cm to 25 mS/cm, from 15 mS/cm to 25 mS/cm, from 15 mS/cm to 22 mS/cm, from 15 mS/cm to 21 mS/cm or from 18 mS/cm to 21 mS/cm.

A second aspect of the invention provides a hybrid electrolyte composition comprising a blend of:
(a) a first blend component consisting of an electrolyte composition according to the first aspect; and
(b) a second blend component consisting of a secondary electrolyte composition comprising a secondary solvent component and a secondary lithium salt component.

The second blend component may comprise any suitable known electrolyte composition which is typically used as an electrolyte in an alkali metal ion secondary cell. The second blend component may comprise one or more lithium salts dissolved in a solvent or mixture of solvents.

In some embodiments, the second blend component comprises a non-aqueous or substantially non-aqueous composition. In some embodiments, the second blend component comprises a non-aqueous or substantially non-aqueous solution comprising one or more lithium salts dissolved in a solvent or mixture of solvents.

In some embodiments, the second blend component is a composition comprising a solvent selected from an organic carbonate compound, or a mixture of organic carbonate compounds, where “organic carbonate compound” is as defined above, and one or more lithium salts. In some embodiments, the second blend component is a composition comprising a solvent selected from ethylene carbonate, propylene carbonate, dimethyl carbonate, ethyl methyl carbonate, diethyl carbonate, fluoroethylene carbonate (FEC), γ-butyrolactone and mixtures thereof; and one or more lithium salt. The one or more lithium salts may be selected from one or more of lithium hexafluorophosphate (LiPF₆), lithium difluorophosphate, lithium 2-trifluoromethyl-4,5-dicyanoimidazolide, lithium difluoro(oxalato)borate, lithium bis(oxalato) borate, lithium tetrafluroborate, lithium bis(trifluoromethanesulfonyl)imide, and lithium bis(fluorosulfonyl)imide.

In addition to the solvent and lithium salt, the second blend component may optionally also contain an additive. In some embodiments, the additive comprises one or more of fluoroethylene carbonate and vinylene carbonate.

In some embodiments, the second blend component is a composition comprising:
a solvent selected from ethylene carbonate, propylene carbonate, dimethyl carbonate, ethyl methyl carbonate, diethyl carbonate, fluoroethylene carbonate (FEC), γ-butyrolactone and mixtures thereof; and
one or more lithium salts selected from one or more of lithium hexafluorophosphate (LiPF₆), lithium difluorophosphate, lithium 2-trifluoromethyl-4,5-dicyanoimidazolide, lithium difluoro(oxalato)borate, lithium bis(oxalato) borate, lithium tetrafluroborate, lithium bis(trifluoromethanesulfonyl)imide, and lithium bis(fluorosulfonyl)imide; and
optionally an additive selected from one or more of fluoroethylene carbonate and vinylene carbonate.

In some embodiments, the second blend component is a composition comprising:
(a) 5-35 wt % of lithium salt
(b) 2-10 wt % of additive; and
(c) 55-93 wt % solvent;
wherein the lithium salt comprises:
(ai) a salt selected from lithium 2-trifluoromethyl-4,5-dicyanoimidazolide, lithium difluoro(oxalato)borate, lithium bis(oxalato) borate and lithium tetrafluroborate; and optionally
(aii) a co-salt selected from lithium bis(trifluoromethanesulfonyl)imide and/or lithium bis(fluorosulfonyl)imide;
wherein the molar ratio of the salt to co-salt is between 100:0 and 5:95;
with the proviso that the composition does not comprise lithium bis(fluorosulfonyl)imide alongside lithium difluoro(oxalato)borate or lithium tetrafluroborate;
and wherein the additive comprises fluoroethylene carbonate and 10-70 mol % vinylene carbonate;
and wherein the solvent comprises either (ci) ethylene carbonate and 10-30 mol % propylene carbonate, or (cii) γ-butyrolactone and optionally ethylene carbonate.

In some embodiments, the lithium concentration in the second blend component is between about 0.5 M and 2.0 M.

In some embodiments, the second blend component consists of (a) 5-35 wt % of lithium salt; (b) 2-10 wt % of additives; and (c) 55-93 wt % solvent.

In some embodiments, the additive in the second blend component consists of 30-90 mol % fluoroethylene carbonate and 10-70 mol % vinylene carbonate.

In some embodiments, the solvent in the second blend component consists of either (ci) 70-90 mol % ethylene carbonate and 10-30 mol % propylene carbonate, or (cii) 10-100 mol % γ-butyrolactone and optionally 0-90 mol % ethylene carbonate.

In some embodiments, the second blend component comprises 5-25 wt % of lithium salt, 2-10 wt % of additive and 65-93 wt % of solvent; wherein
(a) the lithium salt comprises 20-100 mol % lithium tetrafluroborate, and 0-95 mol % lithium bis(trifluoromethanesulfonyl)imide;
(b) the additive comprises 30-90 mol % fluoroethylene carbonate and 10-70 mol % vinylene carbonate; and
(c) the solvent comprises 70-90 mol % ethylene carbonate and 10-30 mol % propylene carbonate.

In some embodiments, the second blend component comprises 5-25 wt % of lithium salt, 2-10 wt % of additive and 65-93 wt % of solvent; wherein
(a) the lithium salt comprises 20-100 mol % of a mixture of lithium 2-trifluoromethyl-4,5-dicyanoimidazolide and lithium bis(oxalato) borate, and 0-95 mol % lithium bis(fluorosulfonyl)imide;
(b) the additive comprises 30-90 mol % fluoroethylene carbonate and 10-70 mol % vinylene carbonate; and
(c) the solvent comprises 70-90 mol % ethylene carbonate and 10-30 mol % propylene carbonate.

In some embodiments, the second blend component comprises 15-35 wt % of lithium salt, 2-10 wt % of additive and 55-83 wt % of solvent; wherein
(a) the lithium salt comprises 5-100 mol % of a mixture of lithium 2-trifluoromethyl-4,5-dicyanoimidazolide and lithium bis(oxalato) borate, and 0-95 mol % lithium bis(fluorosulfonyl)imide;
(b) the additive comprises 30-90 mol % fluoroethylene carbonate and 10-70 mol % vinylene carbonate; and
(c) the solvent comprises 0-90 mol % ethylene carbonate and 10-100 mol % γ-butyrolactone.

***The above composition is the definition of the P3 electrolyte defined in the copy of the earlier application you sent. Has that other application already been filed? Please provide details so that can advise on whether details should be fully disclosed in this new application

WE SHOULD NOT INCLUDE THIS INFORMATION OF THE P3 APPLICA TON HAS NOT YET BEEN FILED**

In some embodiments the hybrid electrolyte composition comprises from 20 wt % to 70 wt % first blend component, for example from 20 wt % to 65 wt %, from 20 wt % to 60 wt %, from 20 wt % to 55 wt %, from 20 wt % to 50 wt %, from 25 wt % to 70 wt %, from 25 wt % to 60 wt %, from 25 wt % to 50 wt %, from 30 wt % to 70 wt %, from 30 wt % to 60 wt %, from 30 wt % to 50 wt %, from 40 wt % to 70 wt %, from 40 wt % to 60 wt % or from 40 wt % to 50 wt %.

In some embodiments the hybrid electrolyte composition comprises from 80 wt % to 30 wt % second blend component, for example from 80 wt % to 35 wt %, from 80 wt % to 40 wt %, from 80 wt % to 45 wt %, from 80 wt % to 50 wt %, from 75 wt % to 30 wt %, from 75 wt % to 40 wt %, from 75 wt % to 50 wt %, from 70 wt % to 30 wt %, from 70 wt % to 40 wt %, from 70 wt % to 50 wt %, from 60 wt % to 30 wt %, from 60 wt % to 40 wt % or from 60 wt % to 50 wt %.

In some embodiments the hybrid electrolyte composition comprises from 20 wt % to 50 wt % first blend component and from 80 wt % to 50 wt % second blend component.

When used in such quantities, the first blend component may augment the electrochemical properties of the second blend component, for example providing a hybrid electrolyte composition having improved rate capability.

A third aspect of the invention is an electrochemical secondary cell comprising
an anode;
a cathode;
a separator between the anode and the cathode; and either
   (a) an electrolyte composition according to the first aspect; or
   (b) a hybrid electrolyte composition according to the second aspect.

The identity of the electrochemically active materials in the cathode and the anode of the cell is not of particular importance. The benefits of the invention based on the use of the electrolyte of the first aspect may be achieved for any active material which could be present in an electrode. The skilled person will be aware of a large number of possible cathode active materials (also called positive active materials) and anode active materials (also called negative active materials) which may be used in the present invention.

There may be certain combinations of active materials and electrolyte which could offer optimal performance. For example, the auxiliary solvent component of the electrolyte may be selected based on a beneficial interaction with the active material of the cathode and/or the anode.

Any suitable anode may be used and the skilled person is aware of materials and methods to manufacture anodes suitable for use in an electrochemical secondary cell.

The anode may comprise a negative active material, a binder and optionally a conductive additive.

In some cases, the negative active material may comprise carbon, suitably graphite, graphene or a blend of carbon and a silicon oxide.

In some embodiments, the negative active material is selected from one or more of graphite, silicon and silicon oxide.

The cathode may comprise a positive active material, a binder and optionally a conductive additive.

In some embodiments, the positive active material is a lithium transition metal oxide material. In some embodiments, the positive active material is a lithium transition metal oxide material comprising a mixed metal oxide of lithium and one or more transition metals, optionally further comprising one or more additional non-transition metals. In some embodiments, the positive active material is a lithium transition metal oxide material comprising lithium and one or more transition metals selected from nickel, cobalt and manganese. In some embodiments, the positive active material is selected from one or more of lithium cobalt oxide (LCO), lithium manganese oxide (LMO), lithium nickel cobalt oxide (NCO), aluminium-doped lithium nickel cobalt oxide (NCA), lithium nickel manganese cobalt oxide (NMC), lithium nickel oxide (LNO), lithium nickel manganese oxide (LNMO), lithium iron phosphate (LFP), lithium manganese iron phosphate (LFP) and lithium nickel vanadate (LNV). In some embodiments, the positive active material is lithium nickel manganese cobalt oxide (NMC), optionally doped with another metal such as aluminium.

Such positive active materials are commercially available or may be manufactured by methods known to the skilled person, for example through the precipitation of mixed metal hydroxide intermediates from a reaction mixture containing different precursor metal salts, followed by calcination to form a mixed metal oxide and optionally lithiation to incorporate lithium into the oxide.

The positive active material may be undoped or uncoated, or may contain one or more dopants and/or a coating. For example, the positive active material may be doped with small amounts of one or more metal elements. The positive active material may comprise a carbon coating on the surface of the particles of the material.

The binder in the anode and/or the cathode may comprise one or more polymers. In some embodiments, the one or more polymers are each independently selected from poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVdF), poly(vinylidene fluoride-co-hexafluoropropylene) (PvDF-HFP), poly(ethylene oxide) (PEO), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene), poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl)(trifluoromethanesulfonyl)imide-co-methoxy-polyethyleneglycolacrylate](Li[PSTFSI-co-MPEGA]), sulfonated poly(phenylene oxide) (PPO), N,N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide(PEO)/poly(lithium sorbate), PEO/poly(lithium muconate), PEO/[poly(lithium sorbate)+BF₃], PEO copolymer, PEO terpolymer, and NIPPON SHOKUBAI® polymer.

The conductive additive in the anode and/or cathode may comprise carbon. In some embodiments the conductive additive comprises one or more of carbon black and graphite. In some embodiments, the conductive additive comprises or consists of carbon black. Examples of commercially available carbon black include Ketjen Black and Super C65.

The separator between the anode and the cathode may be a film disposed between the cathode and the anode. In some embodiments the separator may contact the cathode on one side and the anode on the other side. The separator may be porous, meaning that the separator provides a path for the conduction of ions between the anode and the cathode when the separator is impregnated with the electrolyte composition. In some embodiments the separator is liquid-permeable, allowing the permeation of liquid between the cathode and the anode such that ionic conductivity between the cathode and the anode is facilitated.

The skilled person is aware of suitable materials which may be used as a separator, for example membranes which are available from Celgard.

A fourth aspect of the invention is an electrochemical energy storage device comprising one or more electrochemical secondary cells according to the third aspect. In some embodiments, the electrochemical energy storage device is a battery. In some embodiments, the electrochemical energy storage device is a lithium-ion battery.

The electrochemical energy storage device may provide enhanced runtime at high power draw due to the improved rate capability of the electrolyte.

A fifth aspect of the invention is a method of manufacturing the electrolyte composition according to the first aspect, comprising the steps:
(a) providing a solvent component comprising ethyl acetate; and
(b) adding a lithium salt component comprising one or more lithium salts to the solvent component, such that the final concentration of the lithium salt component in the electrolyte composition is from greater than 1.0 mol·dm⁻³ to less than 3.0 mol·dm⁻³.

All of the options and preferences set out above in relation to the electrolyte composition of the first aspect apply equally to the method of manufacture and will not be repeated. For example, all of the different options for the

In some embodiments, the solvent component is first added to a suitable vessel before adding the lithium salt component to the solvent component and mixing to dissolve.

In some embodiments, the solvent component is heated to a temperature within the range 50 to 90° C. and below the boiling point or flash point of the solvent component, before addition of the lithium salt component.

When the solvent component comprises a mixture of two or more individual solvents, in some embodiments the separate solvents are added to the vessel sequentially and before the addition of the lithium salt component.

In some embodiments, after the solvent component and the lithium salt component have been added to the vessel, the mixture is stirred at a speed between 500 and 1200 rpm using a magnetic stirrer. In some embodiments the mixture is stirred for at least 5 hours, for example at least 8 hours.

In some embodiments, after stirring the mixture is filtered. The mixture may be filtered through a filter having a mesh size of up to 50 μm, for example up to 20 μm, up to 10 μm or up to 5 μm, to ensure the removal of any undissolved material.

In some embodiments, the method comprises choosing an amount of lithium salt component and ethyl acetate to satisfy the following relationship:

[SC]=x/P_{EA}
wherein [SC] is the concentration of the salt component in the electrolyte composition in mol·dm³;
x is from 40 to 60; and
P_{EA} is the amount of ethyl acetate in the solvent component, in wt % based on the total amount of solvent component.

In some embodiments, x is from 45 to 65, or x is about 50. In some embodiments, x is 50.

In some embodiments, the solvent component consists of a mixture of EA and EC, the salt component consists of LiFSI, and the method comprises choosing an amount of lithium salt component and ethyl acetate to satisfy the following relationship:

[SC]=x/P_{EA}
wherein [SC] is the concentration of the salt component in the electrolyte composition in mol·dm³;
x is from 40 to 60; and
P_{EA} is the amount of ethyl acetate in the solvent component, in wt % based on the total amount of solvent component.

In some embodiments, x is from 45 to 65, or x is about 50. In some embodiments, x is 50. All of the compositional options and preferences set out above for the first aspect apply equally to the method of the fifth aspect, including the identities and the relative amounts of the various components of the electrolyte composition.

A sixth aspect of the invention is a method of producing the hybrid electrolyte composition of the second aspect, comprising mixing a first blend component consisting of an electrolyte composition according to the first aspect with a second blend component consisting of a secondary electrolyte composition comprising a secondary solvent component and a secondary lithium salt component.

A seventh aspect of the invention is a method of producing an electrochemical secondary cell of the third aspect, comprising:
(a) assembling an anode, a cathode and a separator together; and
(b) introducing the electrolyte composition according to the first aspect or the hybrid electrolyte composition according to the second aspect into the cell to facilitate ionic conduction between the anode and the cathode.

The invention also provides the use of an electrolyte composition according to the first aspect in an electrochemical secondary cell. The invention also provides the use of an electrolyte composition according to the first aspect to increase the ionic conductivity within an electrochemical secondary cell. The invention also provides the use of an electrolyte composition according to the first aspect to reduce the internal resistance within an electrochemical secondary cell. The invention also provides the use of an electrolyte composition according to the first aspect to increase the rate capability of an electrochemical secondary cell. The invention also provides the use of an electrolyte composition according to the first aspect as an additive to increase the rate capability of a second electrolyte composition.

The invention also provides a method of increasing the rate capability of a second electrolyte composition, comprising adding the electrolyte composition according to the first aspect to the second electrolyte composition.

### BRIEF DESCRIPTION OF THE DRAWINGS

FIG. 1 is a chart showing discharge capacity as a function of C-rate with high Ni cathode and Silicon contained graphite anode at 30 and 45° C. The lines with cross-type markers are electrolyte according to the invention and the lines with triangle markers are comparative electrolyte. The same electrodes and cell format were used, i.e. the only difference was the electrolyte.

FIG. 2 is a chart showing discharge capacity retention as a function of C-rate with high Ni cathode and Silicon contained graphite anode at 30 and 45° C. The lines with cross-type markers are electrolyte according to the invention and the lines with triangle markers are comparative electrolyte. The same electrodes and cell format were used, i.e. the only difference was the electrolyte.

FIG. 3 is a chart showing discharge capacity as a function of C-rate with high Ni cathode and Silicon contained graphite anode at 30 and 45° C. (under testing). The lines with cross-type markers are electrolyte according to the invention and the lines with triangle markers are comparative electrolyte. The inventive electrolyte was tested up to 20C while the comparative electrolyte was to 10C. The same electrodes and cell format were used, i.e. the only difference was the electrolyte.

FIG. 4 is a bar chart showing the effect on capacity retention after 10, 20, 30, 40 and 50 cycles of adding LiPF₆ salt to the electrolyte of the invention.

FIG. 5 is an ionic conduction heatmap for LiFSI salt in EC/EA solvent generated using an AEM simulation.

### EXAMPLES

The following method was followed to prepare all electrolyte compositions:
A Duran bottle, cap and pouring ring were cleaned with isopropyl alcohol (IPA) and dried with compressed air.

All glassware was clean with no residue visible. All cleaned glassware was then allowed to dry in an oven under vacuum for 1 hour.

If some of the solvents are solid, the hot plate stirrer was set to 60° C. and the over temperature cut off to 80° C., while ensuring that this did not exceed the boiling or flash point temperature of the solvent.

The Duran Bottle was weighed with cap and pouring ring and the weight recorded. The Duran Bottle was weighed again with magnetic stirrer bar (“flea”) and cap and the weight recorded. The Duran Bottle was placed onto the hot plate at 60° C. to pre-warm the vessel. The Duran Bottle was then placed on scales with the funnel and the scales were zeroed.

The first raw material was charged into the Duran bottle and the details of the charge were recorded. The solvent was added to the bottle before any solid components, to avoid the clumping of powders caused by adding solvent to dry powder.

The funnel was removed and the cap was replaced before removing the bottle from the scales. The scales were zeroed and the capped bottle was then returned to the scales and the weight recorded to ensure the correct charge of solvent had been achieved.

When further co-solvents were to be added, the funnel was replaced and the scales were zeroed, then the above steps were repeated until all solvent charges were complete.

After all solvent had been added, the bottle was placed on a stirrer and agitated at 1000 rpm or at the maximum stir speed to produce a stable vortex without excessive splashing. A boss and clamp were used to secure the Duran Bottle during stirring.

Each of the solid components were pre-dispensed and charged into the bottle in turn.

For improved accuracy when charging smaller powder quantities, the powder was pre-dispensed into a weighing boat or suitable container prior to addition to the bulk electrolyte, and details were recorded on the mix sheet. A funnel was used to aid charging into the solvent.

For components where several full bottles of powder were required to be added to the solvent, the bottles of salts or additives were all placed on the scales and the scales were zeroed. One full bottle was then removed and charged to the solvent through a funnel, taking care not to create a dust cloud and at a speed to avoid excessive clumping. The empty bottle and lid were then returned to the scales. This was then repeated for further bottles from the scales in turn, until the scales read close to the target charge weight. For accuracy, the final portion to make the target weight was then pre-dispensed into a weighing boat for the final addition to the solvent.

The Duran bottle was returned with cap to zeroed scales and weight was recorded on the mix sheet. The Duran bottle was replaced on the stirrer and secured with the clamp. The solution was agitated overnight at 1000 rpm with vortexing until fully dissolved. After mixing overnight, the magnetic stirrer bar was removed from the Duran bottle with a magnetic flea catcher taking care not to let large fleas drop back into solution.

The electrolyte was visually inspected for contamination and any particulates or discoloration reported on the mix sheet.

Using a ‘Burkle’ bottle vacuum pump, the electrolyte was filtered through a 5 μm filter into a clean bottle.

A density reading was taken using a 5 mL volumetric flask.

Using EQ024 scales, a volumetric flask was weighed and the scales were zeroed, before removing the flask from the scales and leaving the reading on the scales

In a fume cupboard a small volume of electrolyte was decanted into a 100 mL glass beaker. Using a pipette the volumetric flask was filled to white marker line. The volumetric flask was replaced on the scales and the reading was recorded. The density was recorded on the mix sheet.

A sample of electrolyte was taken and the moisture content was measured by Karl fisher analysis.

Another sample was taken and IR and UV spectra were obtained. The trace was verified against a standard spectrum where available.

The following electrolyte compositions were prepared using the above method:

| | | | | | | | | | Total salt |
|---|---|---|---|---|---|---|---|---|---|
| | Component Amounts/wt % | | | | | | | | concentration/ |
| Example | EA | EC | DMC | LiFSI | LiDFOB | LiPF₆ | VC | FEC | mol · dm⁻³ |
| A | — | 24 | 56 | — | — | 14 | 3 | 3 | 1.0 |
| 1 | 56.82 | — | — | 35.84 | 2.4 | — | 3.26 | 1.68 | 2.5 |
| 2 | 28.41 | 28.41 | — | 35.84 | 2.4 | — | 3.26 | 1.68 | 2.5 |
| 3 | 63.99 | — | — | 28.05 | 2.4 | — | 3.67 | 1.89 | 2.0 |
| 4 | 62.56 | — | — | 29.61 | 2.4 | — | 3.59 | 1.85 | 2.1 |
| 5 | 5.97 | — | 53.72 | 32.73 | 2.4 | — | 3.43 | 1.76 | 2.3 |
| 6 | 6.04 | — | 54.33 | 31.92 | — | 2.47 | 3.46 | 1.78 | 2.3 |
| 7 | 59.69 | — | — | 32.73 | 2.4 | — | 3.43 | 1.76 | 2.3 |
| 8 | 53.72 | — | 5.97 | 32.73 | 2.4 | — | 3.43 | 1.76 | 2.3 |
| 9 | 29.84 | — | 29.84 | 32.73 | 2.4 | — | 3.43 | 1.76 | 2.3 |
| 10 | 71.16 | — | — | 20.26 | 2.4 | — | 4.08 | 2.1 | 1.5 |
| 11 | 68.29 | — | — | 23.38 | 2.4 | — | 3.92 | 2.02 | 1.7 |
| 12 | 65.42 | — | — | 26.49 | 2.4 | — | 3.75 | 1.93 | 1.9 |
| 13 | 64.56 | — | — | 27.36 | — | 2.47 | 3.71 | 1.91 | 2.0 |

EA = ethyl acetate
EC = ethylene carbonate
DMC = dimethyl carbonate
LiFSI = lithium bis(trifluoromethanesulfonyl)imide
LiDFOB = lithium difluoro(oxalato)borate
LiPF₆ = lithium hexafluorophosphate
VC = vinylene carbonate
FEC = fluoroethylene carbonate

Example A is a comparative composition.

The concentrations of the salts in the inventive electrolytes are provided in the table below:

Concentration/mol · dm⁻³

| | | | | Total salt |
|---|---|---|---|---|
| Example | LiFSI | LiDFOB | LiPF₆ | concentration |
| 1 | 2.3 | 0.2 | — | 2.5 |
| 2 | 2.3 | 0.2 | — | 2.5 |
| 3 | 1.8 | 0.2 | — | 2.0 |
| 4 | 1.9 | 0.2 | — | 2.1 |
| 5 | 2.1 | 0.2 | — | 2.3 |
| 6 | 2.1 | — | 0.2 | 2.3 |
| 7 | 2.1 | 0.2 | — | 2.3 |
| 8 | 2.1 | 0.2 | — | 2.3 |
| 9 | 2.1 | 0.2 | — | 2.3 |
| 10 | 1.3 | 0.2 | — | 1.5 |
| 11 | 1.5 | 0.2 | — | 1.7 |
| 12 | 1.7 | 0.2 | — | 1.9 |
| 13 | 1.8 | — | 0.2 | 2.0 |

The electrolyte compositions were tested in cells to determine the first cycle efficiency and rate capacity at various discharge rates, as illustrated in the Figures.

Electrochemical evaluations of the electrolytes were carried out with Swagelok or pouch type cells. All the cells had one layer of cathode with areal coating weight over 150 g/m², which consisted of over 90 wt % a high nickel NMC active material and one layer of anode with areal coating weight over 100 g/m², which consisted of over 90 wt % graphite/SiOx mixed active material. The electrodes were prepared with in-house equipment with standard steps including mixing, coating, drying, calendaring and cutting.

Cell assembly was carried out in a dry-room with Dew point less than −40° C. By design, the nominal capacity was about 3.5 mAh or 40.0 mAh for Swagelok or pouch type cells, respectively. The capacity balance was controlled at about 85-90% utilisation of the anode. For all the cells, glass fibre separators were used and 70 μL or 1 mL of electrolyte was added for Swagelok or pouch cells, respectively.

All the cells were electrochemically formed at 30° C. The cell was initially charged with a current of C/20 (a current with which it takes 20 hours to fully charge or discharge the cell) for the first hour and then increased to C/10 for the rest of charging until the cell voltage reached the cut-off voltage of 4.2 V. Then the cell was discharged at C/10 until the cut-off voltage of 2.5 V. The cell underwent two more cycles with the same cut-off voltages at C/10 for both charging and discharging. The first-cycle efficiency was determined by the first cycle charging capacity divided by first cycle discharging capacity and presented as a percentage. Once a cell passed this formation step, rate capability was tested at 30 and 45° C., sequentially. The C-rates were calculated based on cathode nominal capacity (active material weight times its theoretical capacity). In a rate capability test, all the charging was carried out at current of C/5 while the discharging ranged from C/10 to 10C. The rate capacities were thus determined, which can be further normalised by dividing the C/10 capacity from the same test.

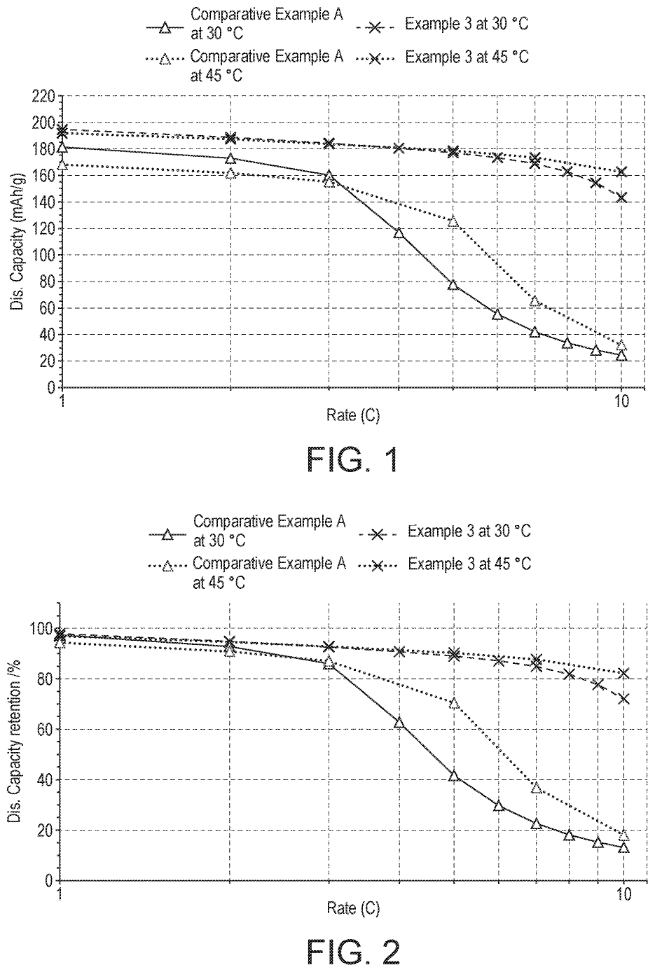

FIG. 1 shows the results of discharge capacity testing at 30° C. and 45° C. for the electrolyte of Example 3 and the electrolyte of Comparative Example A. At both temperatures the electrolyte of Example 3 retains a higher discharge capacity when a higher rate of discharge is applied, relative to the comparative electrolyte. The improvement is particularly pronounced at 3C and above.

FIG. 2 shows the results of capacity retention testing at 30° C. and 45° C. for the electrolyte of Example 3 and the electrolyte of Comparative Example A. At both temperatures the electrolyte of Example 3 demonstrates greater capacity retention when higher discharge rates are applied, relative to the comparative electrolyte. The improvement is particularly pronounced at 3C and above.

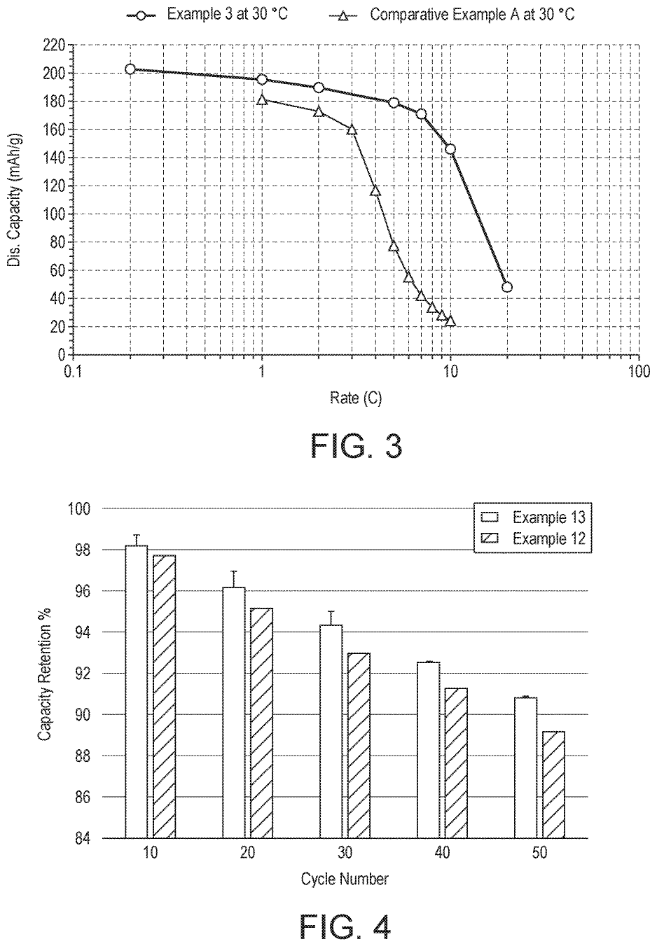

FIG. 3 shows the results of discharge capacity testing at 30° C. and 45° C. for the electrolyte of Example 3 and the electrolyte of Comparative Example A. At both temperatures the electrolyte of Example 3 retains a higher discharge capacity when a higher rate of discharge is applied, relative to the comparative electrolyte. The improvement is particularly pronounced at 3C and above.

FIG. 4 shows the effect of adding LiPF₆ to the electrolyte by plotting the capacity retention of the electrolytes of Examples 12 and 13 after 10, 20, 30, 40 and 50 discharge cycles. At each stage, the capacity retention of the LiPF₆-containing electrolyte (Example 13) is improved relative to the electrolyte which does not contain LiPF₆(Example 12) The magnitude of the improvement increases with the number of discharge cycles, demonstrating the potential effect of LiPF₆ presence on battery lifetime.

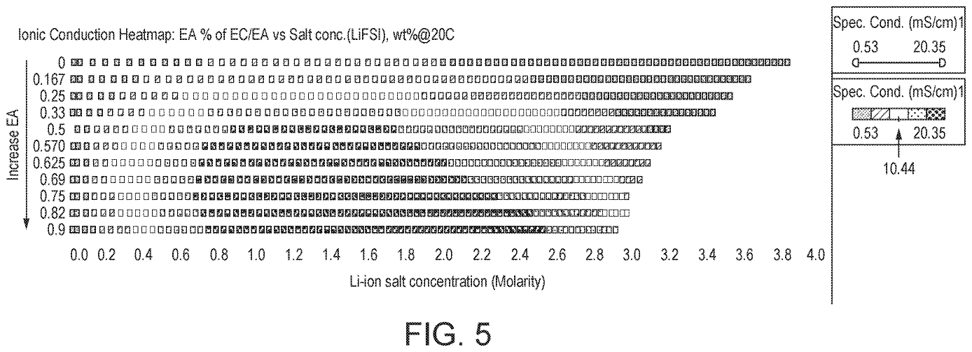

FIG. 5 shows the results of an Advanced Electrolyte Model (AEM) simulation of electrolyte ionic conduction. AEM is a theoretical model for calculating the properties of electrolytes first developed by Kevin Gering at Idaho National Laboratory (K. L. Gering, Electrochim. Acta, 51, 3125, 2006; and K. L. Gering, Electrochim. Acta, 225, 175, 2017). AEM uses a statistical-mechanics framework based on the Nonprimitive, Nonrestricted Associated form of the Mean Spherical Approximation (NPNRAMSA). From this foundation many thermodynamic and transport quantities are derived.

The dark region in the centre of the chart in FIG. 5, which extends between about 0.8 and 2.0 mol·dm⁻³ on the x-axis and between about 0.5 and 0.9 on the y-axis, represents high specific conductance (electrolytic conductivity). Within this region, a darker shade indicates a greater specific conductance. The lighter “band” surrounding this central region represents intermediate specific conductance, and the darker peripheral regions to the left side and the top-right corner of the chart represent low specific conductance values.

The lowest specific conductance value represented in FIG. 5, to the left-hand side around x=0 and to the top-right corner, is approximately 0.5 mS·cm⁻¹. The highest specific conductance value represented in FIG. 5, in the dark central region at around x=1.6 and y=0.9, is approximately 20 mS·cm⁻¹.

The results of the AEM calculation in FIG. 5 show that the specific conductance (electrolytic conductivity) in mS·cm⁻¹ for an EC/EA mixed solvent system containing LiFSI salt increases as the proportion of EA in the solvent increases. The highest conductance is observed when the amount of EA is 70 wt % or greater. Specific conductance also peaks at an intermediate LiFSI salt concentration (around 1.5 mol·dm⁻³).

FIG. 5 also reveals that the peak in specific conductance shifts to higher salt concentration as the proportion of EA in the electrolyte increases. In other words, the higher the proportion of EA in the solvent, the greater the amount of dissolved LiFSI necessary to achieve optimal conductance. For solvent containing around 60 wt % EA, the highest conductance is observed at a LiFSI concentration of around 1.2 mol·dm⁻³. For solvent containing around 90 wt % EA, the highest conductance is observed at a LiFSI concentration of around 1.8 mol·dm⁻³. Thus the following formula allows the calculation of the salt concentration to employ to achieve the optimal specific conductance for a given solvent composition:

$${[ LiFSI ]}_{opt} = 50 / {P}_{EA}$$

where [LiFSI]ₒₚₜ is the concentration of LiFSI in mol·dm⁻³ and P_{EA} is the amount of ethyl acetate in the solvent in wt %, based on the total solvent weight.

1. An electrolyte composition comprising:
a solvent component comprising ethyl acetate; and
a lithium salt component comprising one or more lithium salts;
wherein the concentration of the lithium salt component in the electrolyte composition is from greater than 1.0 mol·dm⁻³ to less than 3.0 mol·dm⁻³.

2. The electrolyte composition according to claim 1, wherein the solvent component comprises at least 50 wt % ethyl acetate, based on the total weight of solvent component.

3. The electrolyte composition according to claim 1, wherein the solvent component comprises at least 70 wt % ethyl acetate, based on the total weight of solvent component.

4. The electrolyte composition according to claim 1, wherein the solvent component contains less than 60 wt % organic carbonate compounds, based on the total weight of solvent component.

5. The electrolyte composition according to claim 1, wherein the solvent component contains less than 30 wt % organic carbonate compounds, based on the total weight of solvent component.

6. The electrolyte composition according to claim 1, wherein the solvent component consists essentially of ethyl acetate.

7. The electrolyte composition according to claim 1, wherein the solvent component is non-aqueous.

8. The electrolyte composition according to claim 1, wherein the lithium salt component comprises one or more of lithium hexafluorophosphate (LiPF₆), lithium bis(trifluoromethanesulfonyl)imide (LiTFSI), lithium bis(fluorosulfonyl)imide (LiFSI), lithium difluoro (oxalato) borate (LiDFOB), lithium difluorophosphate and lithium bis(oxalato) borate.

9. The electrolyte composition according to claim 1, wherein the lithium salt component consists essentially of a mixture of LiPF₆ and LiFSI.

10. The electrolyte composition according to claim 1, wherein the lithium salt component consists essentially of LiFSI.

11. The electrolyte composition according to claim 1, wherein the concentration of the lithium salt component in the electrolyte composition is from 1.5 mol·dm⁻³ to 2.8 mol·dm⁻³.

12. The electrolyte composition according to claim 1, wherein the electrolyte composition further comprises an auxiliary solvent component comprising one or more of vinylene carbonate (VC), vinyl ethylene carbonate (VEC), 1,3-propane sultone (PS), and fluoroethylene carbonate (FEC).

13. The electrolyte composition according to claim 12, wherein the electrolyte composition comprises the auxiliary solvent component in an amount of 4-8 wt % based on the total weight of the electrolyte composition.

14. The electrolyte composition according to claim 1, wherein the electrolyte composition has a specific conductance of from 1 mS/cm to 25 mS/cm.

15. (canceled)

16. (canceled)

17. An electrochemical secondary cell comprising:
an anode;
a cathode;
a separator between the anode and the cathode; and
an electrolyte composition according to claim 1.

18. (canceled)

19. (canceled)

20. A method of manufacturing the electrolyte composition of claim 1, comprising the steps:
(a) providing a solvent component comprising ethyl acetate; and
(b) adding a lithium salt component comprising one or more lithium salts to the solvent component, such that the final concentration of the lithium salt component in the electrolyte composition is from greater than 1.0 mol·dm⁻³ to less than 3.0 mol·dm⁻³.

21-23. (canceled)
